(19) United States
(12) Patent Application Publication
(10) Pub. No.: US 2023/0386245 A1
(43) Pub. Date: Nov. 30, 2023

(54) DETECTION DEVICE AND DETECTION SYSTEM

(71) Applicant: Japan Display Inc., Tokyo (JP)

(72) Inventor: Masahiro TADA, Tokyo (JP)

(21) Appl. No.: 18/198,991

(22) Filed: May 18, 2023

(30) Foreign Application Priority Data
May 26, 2022 (JP) 2022-086301

(51) Int. Cl. G06V 40/13; G06V 40/145; G06V 10/94

(52) U.S. Cl. CPC G06V 40/13; G06V 40/145; G06V 10/955; G06V 10/945

(57) ABSTRACT

A detection device includes a ring-shaped housing wearable on a living body, a light source provided inside the housing, an optical sensor provided inside the housing, a battery, and a wireless power receiving element configured to charge the battery. The optical sensor is provided in an area facing the light source inside the housing, and a coil of the power receiving element is provided outside the optical sensor in the housing.

### CROSS-REFERENCE TO RELATED APPLICATION

This application claims the benefit of priority from Japanese Patent Application No. 2022-086301 filed on May 26, 2022, the entire contents of which are incorporated herein by reference.

### BACKGROUND

### 1. Technical Field

The present invention relates to a detection device and a detection system.

### 2. Description of the Related Art

Devices that detect, for example, fingerprints and vein patterns of bodies wearing the devices are used to authenticate individuals. For example, Japanese Patent Application Laid-open Publication No. 2003-093368 (JP-A-2003-093368) discloses that a finger ring-shaped authentication device is provided with an antenna, and the authentication device is supplied with power by radio waves transmitted from an object to be accessed.

Conventional finger ring-shaped devices have the problem that the devices need to be removed when being charged with power, and are unable to collect data while being removed. The finger ring-shaped authentication device of JP-A-2003-093368 is supplied with the power by the radio waves transmitted from a door side serving as the object to be accessed. Therefore, the device stays near the source of the power for only a short time, and thus is difficult to be sufficiently charged with power.

It is an object of the present invention to provide a detection device and a detection system capable of improving a charging efficiency while a housing is worn.

### SUMMARY

A detection device according to an embodiment of the present disclosure includes a ring-shaped housing wearable on a living body, a light source provided inside the housing, an optical sensor provided inside the housing, a battery, and a wireless power receiving element configured to charge the battery. The optical sensor is provided in an area facing the light source inside the housing, and a coil of the power receiving element is provided outside the optical sensor in the housing.

A detection system according to an embodiment of the present disclosure includes a detection device, and a power supply device configured to supply power to the detection device. The detection device includes a ring-shaped housing wearable on a living body, a light source provided inside the housing, an optical sensor provided inside the housing, a battery, and a wireless power receiving element configured to charge the battery, the optical sensor is provided in an area facing the light source inside the housing, a coil of the power receiving element is provided outside the optical sensor in the housing, and the power supply device comprises a power supply element capable of supplying power to the power receiving element of the detection device.

### BRIEF DESCRIPTION OF THE DRAWINGS

FIG. 1 is a schematic view illustrating a component arrangement example in a state where a finger is accommodated inside a detection device according to a first embodiment, when viewed from one end side of a housing;

FIG. 2 is a schematic sectional view taken along section A-A illustrated in FIG. 1;

FIG. 3 is an external view of the detection device illustrated in FIG. 1 when not being worn;

FIG. 4 is a configuration diagram illustrating an example of light sources and an optical sensor of the detection device according to the first embodiment;

FIG. 5 is a block diagram illustrating a configuration example of the detection device according to the first embodiment;

FIG. 6 is a circuit diagram illustrating the detection device;

FIG. 7 is a circuit diagram illustrating a plurality of partial detection areas;

FIG. 8 is a configuration diagram illustrating an exemplary configuration of a power receiving element and a battery;

FIG. 9 is a configuration diagram illustrating an example of the power receiving element according to a modification of the first embodiment;

FIG. 10 is a configuration diagram illustrating another example of the power receiving element according to the modification of the first embodiment;

FIG. 11 is a configuration diagram illustrating an exemplary system configuration of a detection system according to a second embodiment;

FIG. 12 is a configuration diagram illustrating an exemplary system configuration of the detection system according to a third embodiment;

FIG. 13 is a configuration diagram illustrating an exemplary system configuration of the detection system according to a fourth embodiment;

FIG. 14 is a configuration diagram illustrating an exemplary system configuration of the detection system according to a fifth embodiment;

FIG. 15 is a configuration diagram illustrating another exemplary system configuration of the detection system according to the fifth embodiment; and

FIG. 16 is a configuration diagram illustrating an exemplary system configuration of the detection system according to a sixth embodiment.

### DETAILED DESCRIPTION

The following describes modes (embodiments) for carrying out the present invention in detail with reference to the drawings. The present invention is not limited to the description of the embodiments to be given below. Components to be described below include those easily conceivable by those skilled in the art or those substantially identical thereto. In addition, the components to be described below can be combined as appropriate. What is disclosed herein is merely an example, and the present invention naturally encompasses appropriate modifications easily conceivable by those skilled in the art while maintaining the gist of the invention. To further clarify the description, the drawings may schematically illustrate, for example, widths, thicknesses, and shapes of various parts as compared with actual aspects thereof. However, they are merely examples, and interpretation of the present invention is not limited thereto. The same component as that described with reference to an already mentioned drawing is denoted by the same reference numeral through the description and the drawings, and detailed description thereof may not be repeated where appropriate.

In the present specification and claims, in expressing an aspect of disposing another structure above a certain structure, a case of simply expressing “above” includes both a case of disposing the other structure immediately above the certain structure so as to contact the certain structure and a case of disposing the other structure above the certain structure with still another structure interposed therebetween, unless otherwise specified.

### First Embodiment

Detection Device

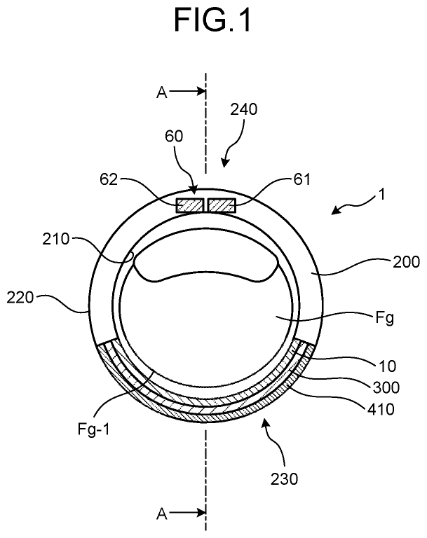

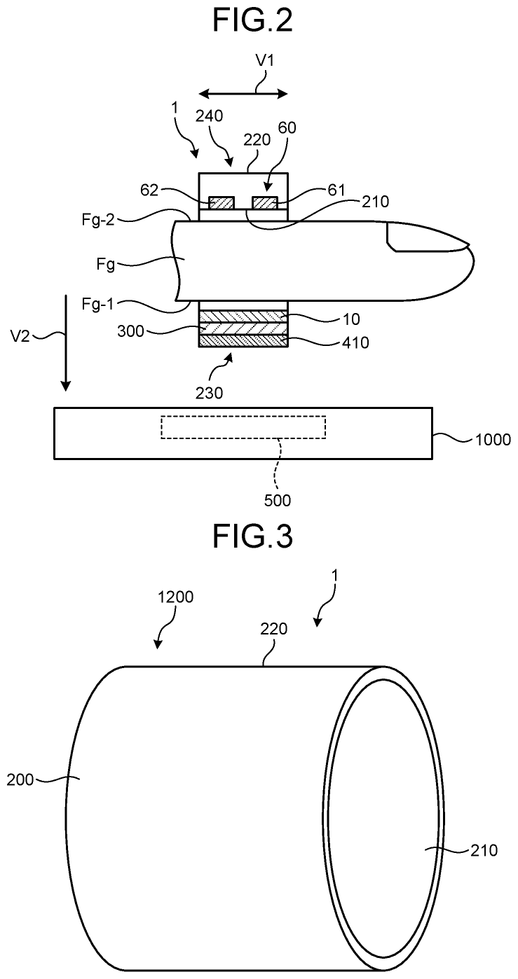

FIG. 1 is a schematic view illustrating a component arrangement example in a state where a finger is accommodated inside a detection device according to a first embodiment, when viewed from one end side of a housing. FIG. 2 is a schematic sectional view taken along section A-A illustrated in FIG. 1. FIG. 3 is an external view of the detection device illustrated in FIG. 1 when not being worn.

A detection device 1 illustrated in FIGS. 1 and 2 is a finger ring-shaped device that can be worn on and removed from a person to be authenticated, and is worn on a finger Fg of the person to be authenticated. The term “finger Fg” includes, for example, a thumb, an index finger, a middle finger, a ring finger, and a little finger. The person to be authenticated is a person whose identity is to be verified by the detection device 1, and is an example of a living body. The detection device 1 includes a housing 200, a light source 60, an optical sensor 10, a battery 300, and a wireless power receiving element 410. The detection device 1 is operated by electric power supplied from the battery 300. The detection device 1 is configured to wirelessly receive power through the power receiving element 410 and charge the battery 300. The detection device 1 may include a wristband.

As illustrated in FIG. 3, the housing 200 is formed in a ring shape wearable on the finger Fg of the person to be authenticated, and has an inner diameter sized according to the size of the finger Fg that wears the housing 200. The housing 200 is formed in the ring shape (annular shape) from a material such as a ceramic, a synthetic resin, a metal, or an alloy. In the present embodiment, the housing 200 is formed of a ceramic to obtain a higher efficiency of power transmission than that obtained by a metal housing formed of a metal. The housing 200 has an inner peripheral surface 210 and an outer peripheral surface 220. As illustrated in FIG. 2, the housing 200 is formed to have a size allowing movement in an attach/detach direction V1 with respect to the finger Fg. The inner peripheral surface 210 is a surface that contacts and faces the finger Fg located inside the housing 200. The outer peripheral surface 220 is a surface that comes in proximity to or in contact with another object as the finger Fg wearing the housing 200 moves.

As illustrated in FIGS. 1 and 2, the housing 200 is provided therein with a plurality of the light sources 60, the optical sensor 10, the battery 300, and the power receiving element 410. The housing 200 is provided with the optical sensor 10, the battery 300, and the power receiving element 410 in a first area 230 that is approached by a finger pulp Fg-1 when the housing 200 is worn on the finger Fg. The finger pulp Fg-1 is an inner side of the finger Fg when the hand is closed. The first area 230 is an area set below the housing 200. In the housing 200, the optical sensor 10, the battery 300, and the power receiving element 410 are arranged in this order from the inner peripheral surface 210 side. That is, the arrangement in the housing 200 is made so as to locate the power receiving element 410 near the outer peripheral surface 220. The optical sensor 10, the battery 300, and the power receiving element 410 can be provided therebetween with, for example, a member of the housing 200 and an insulating member.

While the housing 200 is worn on the finger Fg, the power receiving element 410 is located closer to the outer peripheral surface 220 on the finger pulp Fg-1 side. The first area 230 of the housing 200 is set based on an area facing the finger pulp Fg-1. The housing 200 may be configured such that the optical sensor 10 is exposed from the inner peripheral surface 210 or accommodated near the inner peripheral surface 210. The housing 200 is configured such that the power receiving element 410 is accommodated near the outer peripheral surface 220, and a magnetic field passes through the housing 200. The power receiving element 410 is provided in the housing 200 so as to be capable of being supplied with the power from the battery 300. With this configuration, when the person to be authenticated operates an operation target object 1000, the housing 200 of the detection device 1 can move in an approaching direction V2 to come closer to a power supply device 500 of the operation target object 1000. The power supply device 500 is a device that wirelessly supplies the power, and is incorporated in the operation target object 1000.

The housing 200 is provided with the light sources 60 in a second area 240 approached by a finger dorsum Fg-2 when the housing 200 is worn on the finger Fg. The finger dorsum Fg-2 is an outer side of finger Fg when the hand is closed. The second area 240 is an area set above the housing 200 and is an area facing the first area 230. The housing 200 has the first area 230 and a second area 24 located above the first area 230. The second area 240 is provided so that the light sources 60 can emit light rays toward the optical sensor 10.

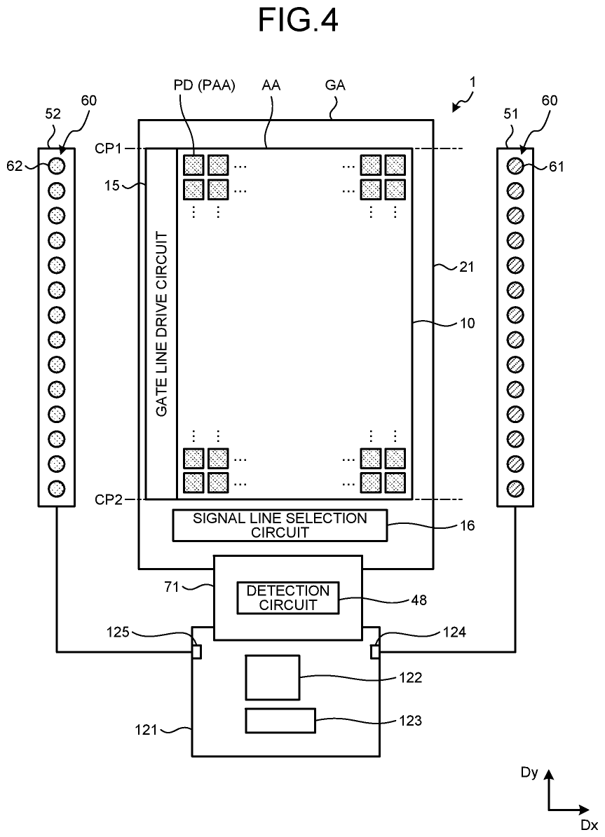

FIG. 4 is a configuration diagram illustrating an example of the light sources 60 and the optical sensor 10 of the detection device 1 according to the first embodiment. In the example illustrated in FIG. 4, the optical sensor 10 includes a sensor substrate 21. The light sources 60 include a plurality of first light sources 61 and a plurality of second light sources 62. In FIGS. 1 and 2 explained above, to simplify the explanation, the number of the light sources 60 is reduced from the actual number.

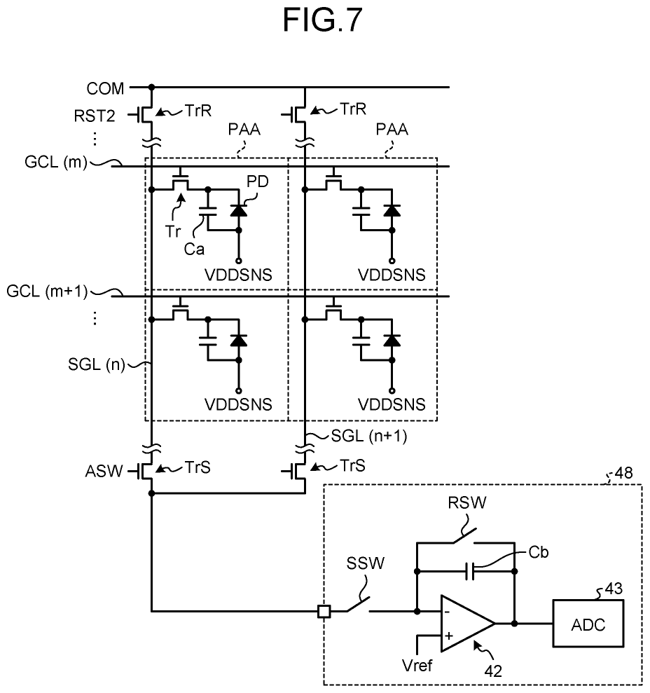

The sensor substrate 21 is electrically coupled to a control substrate 121 through a flexible printed circuit board 71. The flexible printed circuit board 71 is provided with a detection circuit 48. The control substrate 121 is provided with a control circuit 122 and a power supply circuit 123. The control circuit 122 is, for example, a field-programmable gate array (FPGA). The control circuit 122 supplies control signals to the optical sensor 10, a gate line drive circuit 15, and a signal line selection circuit 16 to control detection operations of the optical sensor 10. The control circuit 122 supplies control signals to the first and the second light sources 61 and 62 to control lighting or non-lighting of the first and the second light sources 61 and 62. The power supply circuit 123 supplies voltage signals including, for example, a sensor power supply signal VDDSNS (refer to FIG. 7) to the optical sensor 10, the gate line drive circuit 15, and the signal line selection circuit 16. The power supply circuit 123 supplies a power supply voltage to the first and the second light sources 61 and 62.

The sensor substrate 21 has a detection area AA and a peripheral area GA. The detection area AA is an area provided with a plurality of photodiodes PD included in the optical sensor 10. The peripheral area GA is an area between the outer perimeter of the detection area AA and the ends of the sensor substrate 21, and is an area not overlapping the photodiodes PD.

One side CP1 of the four sides of the detection area AA that form a boundary between the rectangular detection area AA and the peripheral area GA serves as one end of the first area 230. Other one side CP2 of the four sides of the detection area AA located in a position facing the one side with the detection area AA interposed therebetween serves as the other end of the first area 230.

The gate line drive circuit 15 and the signal line selection circuit 16 are provided in the peripheral area GA. Specifically, the gate line drive circuit 15 is provided in an area extending along a second direction Dy in the peripheral area GA. The signal line selection circuit 16 is provided in an area extending along a first direction Dx in the peripheral area GA, and is provided between the optical sensor 10 and the detection circuit 48.

The first direction Dx is one direction in a plane parallel to the sensor substrate 21. The second direction Dy is one direction in the plane parallel to the sensor substrate 21, and is a direction orthogonal to the first direction Dx. The second direction Dy may non-orthogonally intersect the first direction Dx. A third direction Dz is a direction orthogonal to the first direction Dx and the second direction Dy, and is a direction normal to the sensor substrate 21.

The first light sources 61 are provided on a first light source base material 51, and are arranged along the second direction Dy. The second light sources 62 are provided on a second light source base material 52, and are arranged along the second direction Dy. The first light source base material 51 and the second light source base material 52 are electrically coupled, through terminals 124 and 125, respectively, provided on the control substrate 121, to the control circuit 122 and the power supply circuit 123. The first light sources 61 and the second light sources 62 are provided along the finger Fg in the attach/detach direction V1 (refer to FIG. 2), and are arranged so as to face the optical sensor 10.

For example, inorganic light-emitting diodes (LEDs) or organic electroluminescent (EL) diodes (organic light-emitting diodes(OLEDs)) are used as the first and the second light sources 61 and 62. The first and the second light sources 61 and 62 emit first light and second light, respectively, having different wavelengths. In the present embodiment, the first light sources 61 emit near-infrared light having a wavelength of 880 nm. The second light sources 62 emit red light having a wavelength of 665 nm. During detection, the first and the second light sources 61 and 62 are alternately lit up. Therefore, the photodiodes PD alternately receive reflected light of the red light and the near-infrared light.

The reflected light of the near-infrared light contains information for detecting a vascular pattern. Red blood cells included in blood contain hemoglobin. The near-infrared light emitted from the first light sources 61 can be easily absorbed by hemoglobin. In other words, the absorption coefficient of near-infrared light by hemoglobin is higher than that by the other portions in the body. Therefore, the vascular pattern of, for example, veins can be detected by reading the amount of light received by the photodiodes PD, and identifying locations where the amount of the received infrared light is relatively smaller.

The reflected light of the near-infrared light and the red light contains information for measuring the oxygen saturation level in the blood (hereinafter, called “blood oxygen saturation level” (SpO₂)). The blood oxygen saturation level (SpO₂) refers to a ratio of an amount of oxygen actually bound to hemoglobin to the total amount of oxygen under the assumption that the oxygen is bound to all the hemoglobin in the blood.

The near-infrared light can be easily absorbed by hemoglobin. As the amount of hemoglobin increases, the absorbed amount of near-infrared light increases, and the amount of light received by the photodiode PD decreases. That is, the total amount of hemoglobin is obtained from the amount of the received reflected light of the near-infrared light.

The hemoglobin has a dark red color when not being bound to oxygen, and has a bright red color when being bound to oxygen. Therefore, the absorption coefficient of the hemoglobin for absorbing the red light differs between when the hemoglobin is bound to oxygen and when it is not bound to oxygen. As a result, the amount of the reflected light of the red light increases as the hemoglobin bound to oxygen increases in the blood. In contrast, the amount of the reflected light of the red light decreases as the hemoglobin not bound to oxygen increases in the blood. Thus, the amount of the hemoglobin bound to oxygen is relatively obtained based on the amount of the received reflected light of the red light.

Then, by comparing the obtained total amount of the hemoglobin with the amount of the hemoglobin bound to oxygen, the ratio of the amount of oxygen actually bound to the hemoglobin (blood oxygen saturation level (SpO₂)) can be obtained. As described above, the detection device 1 includes the first and the second light sources 61 and 62, and therefore, can detect information on the living body in the finger Fg or the like by performing the detection based on the first light and the detection based on the second light. The detection device 1 can supply the detected information on the living body including, for example, the blood oxygen saturation level and pulsation to the control substrate 121 through the flexible printed circuit board 71.

In the present disclosure, the wavelengths of the light emitted from the first and the second light sources 61 and 62 are not limited to those described above. The first light sources 61 only need to emit the near-infrared light having a wavelength of from 800 nm (inclusive) to 1000 nm (exclusive). The second light sources 62 only need to emit the red light having a wavelength of from 600 nm (inclusive) to 800 nm (exclusive).

The arrangement of the first and the second light sources 61 and 62 illustrated in FIG. 4 is merely exemplary, and may be changed as appropriate. For example, the first and the second light sources 61 and 62 may be arranged on each of the first and the second light source base materials 51 and 52. In this case, a group including the first light sources 61 and a group including the second light sources 62 may be arranged in the second direction Dy, or the first and the second light sources 61 and 62 may be alternately arranged in the second direction Dy. The first and the second light sources 61 and 62 may be provided on one light source base material, or three or more light source base materials. The detection device 1 may include one of the first light sources 61 and one of the second light sources 62.

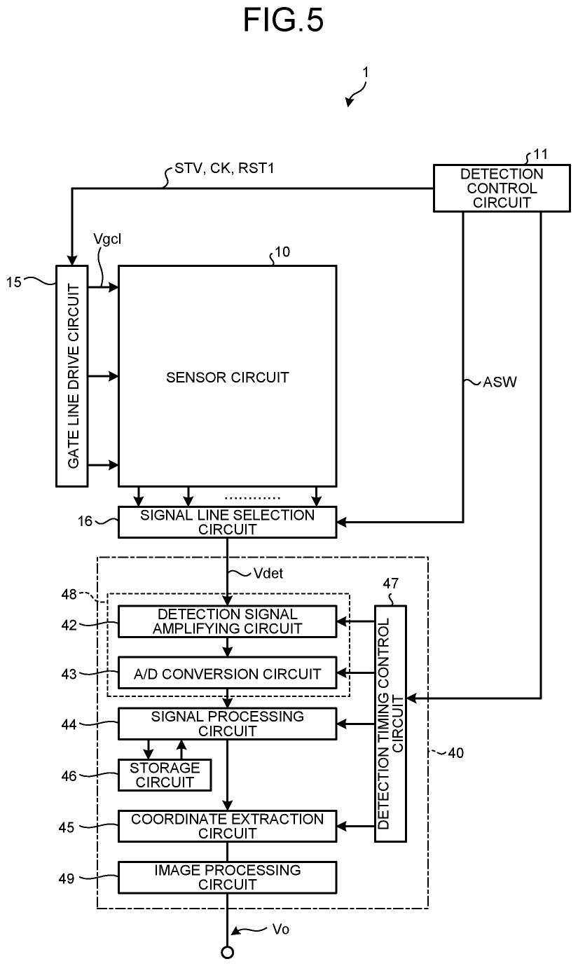

FIG. 5 is a block diagram illustrating a configuration example of the detection device 1 according to the first embodiment. As illustrated in FIG. 5, the detection device 1 further includes a detection control circuit 11 and a detection circuit 40. The control circuit 122 includes one, some, or all functions of the detection control circuit 11. The control circuit 122 also includes one, some, or all functions of the detection circuit 40 except those of the detection circuit 48.

The optical sensor 10 is an optical sensor that includes the photodiodes PD serving as photoelectric conversion elements. Each of the photodiodes PD included in the optical sensor 10 outputs an electrical signal corresponding to light irradiating the photodiode PD as a detection signal Vdet to the signal line selection circuit 16. The optical sensor 10 performs the detection according to a gate drive signal Vgcl supplied from the gate line drive circuit 15.

The detection control circuit 11 is a circuit that supplies respective control signals to the gate line drive circuit 15, the signal line selection circuit 16, and the detection circuit 40 to control operations of these components. The detection control circuit 11 supplies various control signals including, for example, a start signal STV, a clock signal CK, and a reset signal RST1 to the gate line drive circuit 15. The detection control circuit 11 also supplies various control signals including, for example, a selection signal ASW to the signal line selection circuit 16. The detection control circuit 11 also supplies various control signals to the first and the second light sources 61 and 62 to control the lighting and non-lighting of the respective first and second light sources 61 and 62.

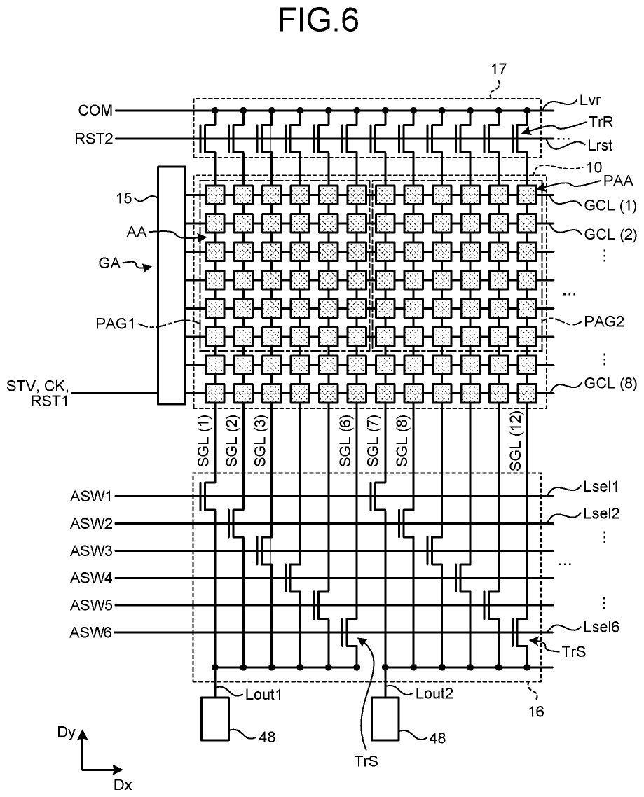

The gate line drive circuit 15 is a circuit that drives a plurality of gate lines GCL (refer to FIG. 6) based on the various control signals. The gate line drive circuit 15 sequentially or simultaneously selects the gate lines GCL, and supplies the gate drive signals Vgcl to the selected gate lines GCL. Through this operation, the gate line drive circuit 15 selects the photodiodes PD coupled to the gate lines GCL.

The signal line selection circuit 16 is a switch circuit that sequentially or simultaneously selects a plurality of signal lines SGL (refer to FIG. 7). The signal line selection circuit 16 is, for example, a multiplexer. The signal line selection circuit 16 couples the selected signal lines SGL to the detection circuit 48 based on the selection signal ASW supplied from the detection control circuit 11. Through this operation, the signal line selection circuit 16 outputs the detection signals Vdet of the photodiodes PD to the detection circuit 40.

The detection circuit 40 includes the detection circuit 48, a signal processing circuit 44, a coordinate extraction circuit 45, a storage circuit 46, a detection timing control circuit 47, and an image processing circuit 49. The detection timing control circuit 47 performs control to cause the detection circuit 48, the signal processing circuit 44, the coordinate extraction circuit and the image processing circuit 49 to operate in synchronization with one another based on a control signal supplied from the detection control circuit 11.

The detection circuit 48 is, for example, an analog front-end (AFE) circuit. The detection circuit 48 is a signal processing circuit having functions of at least a detection signal amplifying circuit 42 and an analog-to-digital (A/D) conversion circuit 43. The detection signal amplifying circuit 42 amplifies the detection signal Vdet. The A/D conversion circuit 43 converts an analog signal output from the detection signal amplifying circuit 42 into a digital signal.

The signal processing circuit 44 is a logic circuit that detects a predetermined physical quantity received by the optical sensor 10 based on output signals of the detection circuit 48. The signal processing circuit 44 can detect asperities on a surface of the finger Fg or a palm based on the signals from the detection circuit 48 when the finger Fg is in contact with or in proximity to a detection surface. The signal processing circuit 44 can detect the information on the living body based on the signals from the detection circuit 48. Examples of the information on the living body include the pulsation and the blood oxygen saturation level of the finger Fg.

The signal processing circuit 44 may also perform processing of acquiring the detection signals Vdet (information on the living body) simultaneously detected by the photodiodes PD, and averaging the detection signals Vdet. In this case, the detection circuit 40 can perform stable detection by reducing measurement errors caused by noise and/or relative positional misalignment between an object to be detected, such as the finger Fg, and the optical sensor 10.

The storage circuit 46 temporarily stores therein signals calculated by the signal processing circuit 44. The storage circuit 46 may be, for example, a random-access memory (RAM) or a register circuit.

The coordinate extraction circuit 45 is a logic circuit that obtains detected coordinates of the asperities on the surface of the finger or the like when the contact or proximity of the finger is detected by the signal processing circuit 44. The coordinate extraction circuit 45 is the logic circuit that also obtains detected coordinates of blood vessels in the finger Fg or the palm. The image processing circuit 49 combines the detection signals Vdet output from the respective photodiodes PD of the optical sensor 10 to generate two-dimensional information representing the shape of the asperities on the surface of the finger Fg or the like and two-dimensional information representing the shape of the blood vessels in the finger Fg or the palm. The coordinate extraction circuit 45 may output the detection signals Vdet as sensor outputs Vo instead of calculating the detected coordinates. A case can be considered where the detection circuit 40 does not include the coordinate extraction circuit 45 and the image processing circuit 49.

The detection control circuit 11 has a function to compare the detected information on the living body with authentication information stored in advance and authenticate the person to be authenticated based on the result of the comparison. The detection control circuit 11 has a function to control transmission of the detected information on the living body to an external device through a communication device (not illustrated in the drawings).

The following describes a circuit configuration example of the detection device 1. FIG. 6 is a circuit diagram illustrating the detection device 1. FIG. 7 is a circuit diagram illustrating a plurality of partial detection areas. FIG. 7 also illustrates a circuit configuration of the detection circuit 48.

As illustrated in FIG. 6, the optical sensor 10 has a plurality of partial detection areas PAA arranged in a matrix having a row-column configuration. Each of the partial detection areas PAA is provided with the photodiode PD.

The gate lines GCL extend in the first direction Dx, and are each coupled to the partial detection areas PAA arranged in the first direction Dx. A plurality of gate lines GCL(1), GCL(2), . . . , GCL(8) are arranged in the second direction Dy, and are each coupled to the gate line drive circuit 15. In the following description, the gate lines GCL(1), GCL(2), . . . , GCL(8) will each be simply referred to as the gate line GCL when need not be distinguished from one another. For ease of understanding of the description, FIG. 7 illustrates eight of the gate lines GCL. However, this is merely an example, and M (where M is 8 or larger, and is, for example, 256) of the gate lines GCL may be arranged.

The signal lines SGL extend in the second direction Dy, and are each coupled to the photodiodes PD in the partial detection areas PAA arranged in the second direction Dy. A plurality of signal lines SGL(1), SGL(2), . . . , SGL(12) are arranged in the first direction Dx, and are each coupled to the signal line selection circuit 16 and a reset circuit 17. In the following description, the signal lines SGL(1), SGL(2), . . . , SGL(12) will each be simply referred to as the signal line SGL when need not be distinguished from one another.

For ease of understanding of the description, 12 of the signal lines SGL are illustrated. However, this is merely an example, and N (where N is 12 or larger, and is, for example, 252) of the signal lines SGL may be arranged. In FIG. 6, the optical sensor 10 is provided between the signal line selection circuit 16 and the reset circuit 17. The present invention is not limited thereto. The signal line selection circuit 16 and the reset circuit 17 may be coupled to ends of the signal lines SGL in the same direction.

The gate line drive circuit 15 receives various control signals including, for example, the start signal STV, the clock signal CK, and the reset signal RST1 from the control circuit 122 (refer to FIG. 4). The gate line drive circuit 15 sequentially selects the gate lines GCL(1), GCL(2), . . . , GCL(8) in a time-division manner based on the various control signals. The gate line drive circuit 15 supplies the gate drive signal Vgcl to the selected one of the gate lines GCL. This operation supplies the gate drive signal Vgcl to a plurality of first switching elements Tr coupled to the gate line GCL, and thus, selects corresponding ones of the partial detection areas PAA arranged in the first direction Dx as detection targets.

The gate line drive circuit 15 may perform different driving for each of detection modes including the detection of a fingerprint and the detection of a plurality of different items of the information on the living body (such as the pulsation and the blood oxygen saturation level). For example, the gate line drive circuit 15 may collectively drive more than one of the gate lines GCL.

Specifically, the gate line drive circuit 15 simultaneously selects a predetermined number of the gate lines GCL from among the gate lines GCL(1), GCL(2), . . . GCL(8) based on the control signals. For example, the gate line drive circuit 15 simultaneously selects six gate lines GCL(1) to GCL(6), and supplies thereto the gate drive signals Vgcl. The gate line drive circuit 15 supplies the gate drive signals Vgcl through the selected six gate lines GCL to the first switching elements Tr. Through this operation, detection area groups PAG1 and PAG2 each including more than one of the partial detection areas PAA arranged in the first direction Dx and the second direction Dy are selected as the respective detection targets. The gate line drive circuit 15 collectively drives the predetermined number of the gate lines GCL, and sequentially supplies the gate drive signals Vgcl to each unit of the predetermined number of the gate lines GCL.

The signal line selection circuit 16 includes a plurality of selection signal lines Lsel, a plurality of output signal lines Lout, and third switching elements TrS. The third switching elements TrS are provided correspondingly to the respective signal lines SGL. Six signal lines SGL(1), SGL(2), . . . , SGL(6) are coupled to a common output signal line Lout1. Six signal lines SGL(7), SGL(8), . . . , SGL(12) are coupled to a common output signal line Lout2. The output signal lines Lout1 and Lout2 are each coupled to the detection circuit 48.

The signal lines SGL(1), SGL(2), . . . , SGL(6) are grouped into a first signal line block, and the signal lines SGL(7), SGL(8), . . . , SGL(12) are grouped into a second signal line block. The selection signal lines Lsel are coupled to the gates of the respective third switching elements TrS included in one of the signal line blocks. One of the selection signal lines Lsel is coupled to the gates of the third switching elements TrS in the signal line blocks.

Specifically, selection signal lines Lsel1, Lsel2, . . . , Lsel6 are coupled to the third switching elements TrS corresponding to the signal lines SGL(1), SGL(2), . . . SGL(6), respectively. The selection signal line Lsel1 is coupled to one of the third switching elements TrS corresponding to the signal line SGL(1) and one of the third switching elements TrS corresponding to the signal line SGL(7). The selection signal line Lsel2 is coupled to one of the third switching elements TrS corresponding to the signal line SGL(2) and one of the third switching elements TrS corresponding to the signal line SGL(8).

The control circuit 122 (refer to FIG. 4) sequentially supplies the selection signal ASW to the selection signal lines Lsel. This operation causes the signal line selection circuit 16 to operate the third switching elements TrS to sequentially select the signal lines SGL in one of the signal line blocks in a time-division manner. The signal line selection circuit 16 selects one of the signal lines SGL in each of the signal line blocks. With the above-described configuration, the detection device 1 can reduce the number of integrated circuits (ICs) including the detection circuit 48 or the number of terminals of the ICs.

The signal line selection circuit 16 may collectively couple more than one of the signal lines SGL to the detection circuit 48. Specifically, the control circuit 122 (refer to FIG. 4) simultaneously supplies the selection signal ASW to the selection signal lines Lsel. This operation causes the signal line selection circuit 16 to operate the third switching elements TrS to select the signal lines SGL (for example, six of the signal lines SGL) in one of the signal line blocks, and couple the signal lines SGL to the detection circuit 48. As a result, the signals detected in each of the detection area groups PAG1 and PAG2 are output to the detection circuit 48. In this case, the signals from the partial detection areas PAA (photodiodes PD) included in each of the detection area groups PAG1 and PAG2 are put together and output to the detection circuit 48.

Through the operations of the gate line drive circuit 15 and the signal line selection circuit 16, the detection is performed for each of the detection area groups PAG1 and PAG2. As a result, the intensity of the detection signal Vdet obtained by a one-time detection operation increases, so that the sensor sensitivity can be improved. The time required for the detection can also be reduced. As a result, the detection device 1 can repeatedly perform the detection in a short time, and thus, can improve the signal-to-noise ratio (S/N), and can also accurately detect a temporal change in the information on the living body, such as a pulse wave.

As illustrated in FIG. 6, the reset circuit 17 includes a reference signal line Lvr, a reset signal line Lrst, and fourth switching elements TrR. The fourth switching elements TrR are provided correspondingly to the signal lines SGL. The reference signal line Lvr is coupled to either the sources or the drains of the fourth switching elements TrR. The reset signal line Lrst is coupled to the gates of the fourth switching elements TrR.

The control circuit 122 supplies a reset signal RST2 to the reset signal line Lrst. This operation turns on the fourth switching elements TrR to electrically couple the signal lines SGL to the reference signal line Lvr. The power supply circuit 123 supplies a reference signal COM to the reference signal line Lvr. This operation supplies the reference signal COM to a capacitive element Ca (refer to FIG. 7) included in each of the partial detection areas PAA.

As illustrated in FIG. 7, each of the partial detection areas PAA includes the photodiode PD, the capacitive element Ca, and a corresponding one of the first switching elements Tr. FIG. 7 illustrates two gate lines GCL(m) and GCL(m+1) arranged in the second direction Dy among the gate lines GCL. FIG. 7 also illustrates two signal lines SGL(n) and SGL(n+1) arranged in the first direction Dx among the signal lines SGL. The partial detection area PAA is an area surrounded by the gate lines GCL and the signal lines SGL. Each of the first switching elements Tr is provided correspondingly to the photodiode PD. The first switching element Tr is formed of a thin-film transistor, and in this example, formed of an re-channel metal oxide semiconductor (MOS) thin-film transistor (TFT).

The gates of the first switching elements Tr belonging to the partial detection areas PAA arranged in the first direction Dx are coupled to the gate line GCL. The sources of the first switching elements Tr belonging to the partial detection areas PAA arranged in the second direction Dy are coupled to the signal line SGL. The drain of the first switching element Tr is coupled to the cathode of the photodiode PD and the capacitive element Ca.

The anode of the photodiode PD is supplied with the sensor power supply signal VDDSNS from the power supply circuit 123. The signal line SGL and the capacitive element Ca are supplied with the reference signal COM that serves as an initial potential of the signal line SGL and the capacitive element Ca from the power supply circuit 123.

When the partial detection area PAA is irradiated with light, a current corresponding to the amount of the light flows through the photodiode PD. As a result, an electric charge is stored in the capacitive element Ca. After the first switching element Tr is turned on, a current corresponding to the electric charge stored in the capacitive element Ca flows through the signal line SGL. The signal line SGL is coupled to the detection circuit 48 through a corresponding one of the third switching elements TrS of the signal line selection circuit 16. Thus, the detection device 1 can detect a signal corresponding to the amount of the light irradiating the photodiode PD in each of the partial detection areas PAA or signals corresponding to the amounts of the light irradiating the photodiodes PD in each of the detection area groups PAG1 and PAG2.

During a read period, a switch SSW of the detection circuit 48 is turned on, and the detection circuit 48 is coupled to the signal lines SGL. The detection signal amplifying circuit 42 of the detection circuit 48 converts a variation of a current supplied from the signal lines SGL into a variation of a voltage, and amplifies the result. A reference voltage Vref having a fixed potential is supplied to a non-inverting input terminal (+) of the detection signal amplifying circuit 42, and the signal lines SGL are coupled to an inverting input terminal (−) of the detection signal amplifying circuit 42. In the present embodiment, the same signal as the reference signal COM is supplied as the reference voltage Vref. The detection signal amplifying circuit 42 includes a capacitive element Cb and a reset switch RSW. During a reset period, the reset switch RSW is turned on, and the electric charge of the capacitive element Cb is reset.

With the above-described configuration, the detection device 1 including the photodiodes PD can detect the information on the living body, such as a vein pattern, a dermatoglyphic pattern, the blood oxygen saturation level, and the pulsation of the finger Fg, and externally supply biometric information including the detected information.

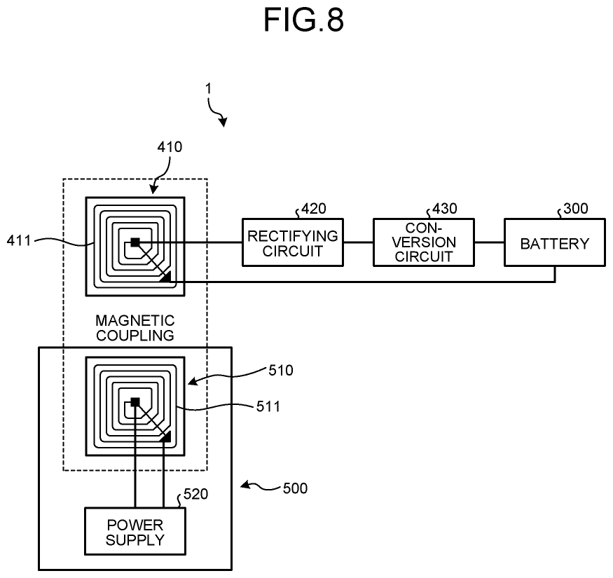

The following describes the power receiving element 410 and the battery 300. FIG. 8 is a configuration diagram illustrating an exemplary configuration of the power receiving element 410 and the battery 300. As illustrated in FIG. 8, the detection device 1 includes the power receiving element 410, a rectifying circuit 420, and a conversion circuit 430. The power receiving element 410 includes a flat coil 411. The coil 411 is a power receiving coil, and is electrically coupled to the rectifying circuit 420. The coil 411 is provided closer to the outer peripheral surface 220 in the first area 230 of the housing 200. When the coil 411 is located proximate to a power transmission coil 511 of the power supply device 500, the coil 411 is magnetically coupled to the power transmission coil 511, receives an electromagnetic field from the power transmission coil 511, and converts the electromagnetic field into an electric current. The coil 411 may be shared with a near-field communication (NFC) antenna, and capture spatial electromagnetic waves to absorb energy.

The power supply device 500 includes a power supply element 510 capable of supplying power to the wireless power receiving element 410 of the detection device 1, and a power supply 520 capable of supplying the power to the power supply element 510. The power supply element 510 includes the power transmission coil 511 for transmitting power to charge the battery 300. The power transmission coil 511 is electrically coupled to the power supply 520. The power transmission coil 511 is a resonant coil, and is operated by a drive voltage from the power supply 520. The power supply 520 is an alternating-current power supply. The power supply device 500 is a device that wirelessly supplies power by magnetically coupling the power transmission coil 511 to the proximate power receiving element 410 on the power receiving side.

The coil 411 of the detection device 1 is electrically coupled to the rectifying circuit 420. The rectifying circuit 420 is, for example, a rectifying circuit that rectifies the current received by the coil 411. The rectifying circuit 420 is electrically coupled to the conversion circuit 430. The conversion circuit 430 is electrically coupled to the battery 300, and converts the current rectified by the rectifying circuit 420 into a direct electric current. When an alternating electric current flows in the power transmission coil 511 on the power transmission side, an alternating magnetic field is generated in the power transmission coil 511, and the alternating magnetic field generates an alternating electric current in the proximate coil 411 in the detection device 1. The detection device 1 converts the generated alternating electric current into the direct electric current, and charges the battery 300. Thus, the detection device 1 is magnetically coupled to establish the wireless power supply.

The battery 300 is a secondary battery. The battery 300 is a chemical battery that can be used while repeatedly charged and discharged. Examples of the battery 300 include a storage battery and a rechargeable battery. The battery 300 is compatible with, for example, Qi (international standard for wireless power supply). The battery 300 can supply stored power to, for example, parts in a detection device 30 that require power. The battery 300 is electrically coupled to the light sources 60 and the optical sensor 10, and supplies the power to the light sources 60, the optical sensor 10, and other parts.

As described above, in the occasion where the person to be authenticated operates the operation target object 1000, when the finger Fg wearing the housing 200 is brought to be close to the power supply device 500 of the operation target object 1000, the coil 411 of the detection device 1 is magnetically coupled to the power transmission coil 511 of the power supply device 500 to charge the battery 300. That is, the detection device 1 can charge the battery 300 without being removed from the finger Fg while being in proximity to the power supply device 500. As a result, the detection device 1 need not be removed from the finger Fg for charging, and therefore, can improve a charging efficiency while being worn on the finger Fg. The same effect is provided even when the detection device 1 is the wristband instead of being finger ring-shaped.

Since the battery 300 is provided between the optical sensor 10 and the coil 411, the battery 300 is located closer to the coil 411, and thus, the detection device 1 can reduce loss of the received power. The housing 200 of the detection device 1 is formed of a ceramic, and therefore, can improve the charging efficiency more than when formed of a metal. Since the light sources 60 include the first and the second light sources 61 and 62 that are alternately arranged, the detection device 1 can efficiently collect the biometric information on the finger Fg.

The configuration example of the detection device 1 according to the present embodiment has been described above. The configuration described above using FIGS. 1 to 8 is merely an example, which does not limit the configuration of the detection device 1 according to the present embodiment. The configuration of the detection device 1 according to the present embodiment can be flexibly modified according to specifications and operations.

For example, the detection device 1 may be configured such that the housing 200 includes a communication device (not illustrated in the drawings). This configuration allows the detection device 1 to be wirelessly charged in the worn state. Therefore, even if the detected biometric information, for example, is transmitted to the external device, the battery 300 can be restrained from lacking power.

Modification of First Embodiment

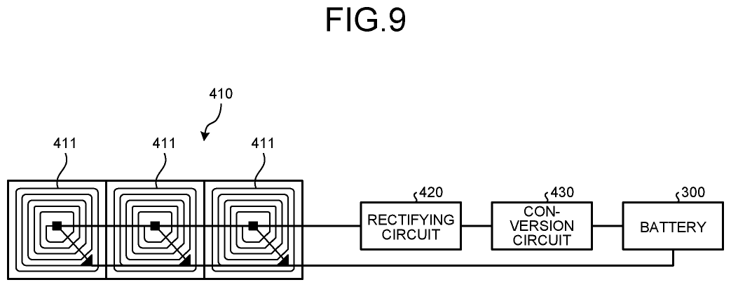

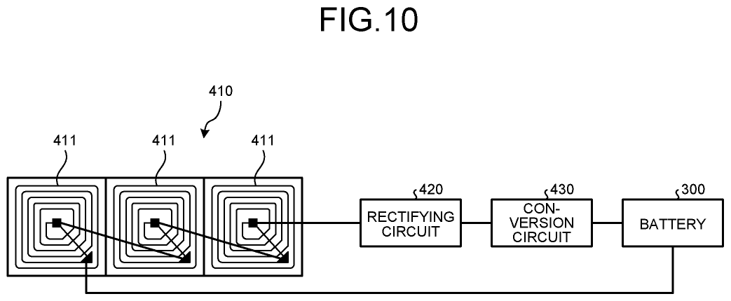

In the first embodiment described above, the case has been described where the power receiving element 410 of the detection device 1 includes the one coil 411, but the power receiving element 410 is not limited to this case. The power receiving element 410 may have a configuration including a plurality of the coils 411. FIG. 9 is a configuration diagram illustrating an example of the power receiving element 410 according to a modification of the first embodiment. FIG. 10 is a configuration diagram illustrating another example of the power receiving element 410 according to the modification of the first embodiment. While cases will be described with reference to FIGS. 9 and 10 where the power receiving element 410 includes three of the coils 411, the number of the coils 411 is not limited to these cases.

As illustrated in FIG. 9, the detection device 1 includes the power receiving element 410 including the coils 411 coupled in parallel, the rectifying circuit 420, and the conversion circuit 430. In the detection device 1, a current received by the coils 411 is supplied to the rectifying circuit 420. The detection device 1 charges the battery 300 using the direct current rectified by the rectifying circuit 420. As a result, the detection device 1 can increase the current of the power receiving element 410 by coupling the coils 411 in parallel. Therefore, the charging efficiency can be improved more than when the battery 300 is charged using the one coil 411.

As illustrated in FIG. 10, the detection device 1 includes the power receiving element 410 including the coils 411 coupled in series, the rectifying circuit 420, and the conversion circuit 430. In the detection device 1, the current received by the coils 411 is supplied to the rectifying circuit 420. The detection device 1 charges the battery 300 using the direct current rectified by the rectifying circuit 420. As a result, the detection device 1 can increase the voltage of the power receiving element 410 by coupling the coils 411 in series. Therefore, the charging efficiency can be improved more than when the battery 300 is charged using the one coil 411.

As described above, in the detection device 1, the power receiving element 410 includes the multiple coils 411, which can be arranged over a wide area of the housing 200. This configuration can increase the first area 230 of the housing 200 of the detection device 1 to widen the area over which the power receiving element 410 can receive power, and thus, can improve the charging efficiency of the battery 300.

In the present embodiment, the detection device 1 has been described for the case where the optical sensor 10, the battery 300, and the power receiving element 410 are provided in the first area 230, but the present embodiment is not limited to this case. For example, the detection device 1 may be provided with at least one of the battery 300 and the power receiving element 410 in the first area 230 and outside thereof.

### Second Embodiment

Detection System

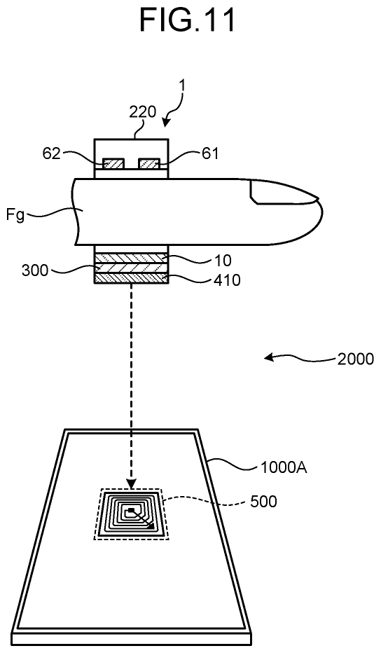

FIG. 11 is a configuration diagram illustrating an exemplary system configuration of a detection system according to a second embodiment. As illustrated in FIG. 11, a detection system 2000 includes the detection device 1 worn on the finger Fg and the power supply device 500 that wirelessly supplies power to the detection device 1. The detection device 1 is the detection device 1 according to the first embodiment, and includes the housing 200, the light sources 60, the optical sensor 10, the battery 300, and the wireless power receiving element 410. The power supply device 500 is the power supply device 500 according to the first embodiment, and includes the power transmission coil 511 for transmitting power and the power supply 520 that supplies the power to the power transmission coil 511. In the present embodiment, the detection system 2000 is a system that can detect the biometric information using the detection device 1, and has the function to authenticate the person to be authenticated based on the biometric information.

The power supply device 500 is provided in a mobile phone 1000A serving as the operation target object 1000. The mobile phone 1000A is a communication apparatus capable of communicating using wireless communication, and is operated while being held by a hand of the person to be authenticated. Examples of the mobile phone 1000A include a smartphone and a feature phone. That is, in the detection system 2000, when the person to be authenticated operates the mobile phone 1000A, the detection device 1 worn on the finger Fg is positioned near the mobile phone 1000A. Therefore, the power supply device 500 is located near the back surface, the operation surface, the side surface, or the like of the mobile phone 1000A approached by the finger Fg of the person to be authenticated. The operation surface is a surface provided with, for example, operation keys or a touch panel. That is, the mobile phone 1000A only needs to be provided with at least the power transmission coil 511 near the surface approached by the finger Fg.

As described above, in the detection system 2000, when the person to be authenticated wearing the detection device 1 operates the mobile phone 1000A, the detection device 1 approaches the power supply device 500, and the coil 411 of the detection device 1 is magnetically coupled to the power transmission coil 511 of the power supply device 500 to automatically charge the battery 300. Thus, the detection system 2000 can charge the battery 300 without the removal of the detection device 1 from the finger Fg while the detection device 1 is in proximity to the power supply device 500. As a result, when operating the mobile phone 1000A, the person to be authenticated can cause the detection system 2000 to charge the detection device 1 and continuously collect information by keeping wearing the detection device 1.

### Third Embodiment

Detection System

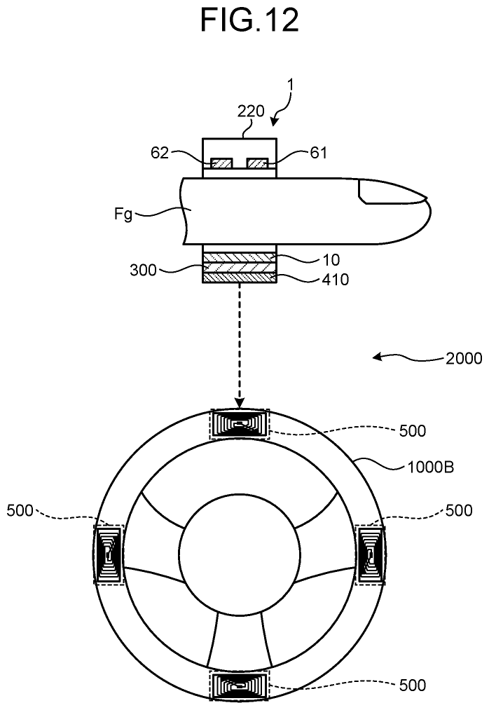

FIG. 12 is a configuration diagram illustrating an exemplary system configuration of the detection system according to a third embodiment. As illustrated in FIG. 12, the detection system 2000 includes the detection device 1 worn on the finger Fg and a plurality of the power supply devices 500 that wirelessly supply power to the detection device 1. The detection device 1 is the detection device 1 according to the first embodiment, and includes the housing 200, the light sources 60, the optical sensor 10, the battery 300, and the wireless power receiving element 410. Each of the power supply devices 500 is the power supply device 500 according to the first embodiment, and includes the power transmission coil 511 for transmitting power and the power supply 520 that supplies the power to the power transmission coil 511.

The respective power supply devices 500 are provided at different locations of a steering wheel 1000B of a mobile object serving as the operation target object 1000. Examples of the mobile object include an automobile, a heavy-duty vehicle, a truck, a motorcycle, and a bicycle. In the example illustrated in FIG. 12, a steering wheel 100B illustrates the steering wheel of an automobile. The steering wheel 1000B is an operating device gripped by a driver to adjust the direction of travel of the mobile object, and various parts are gripped by the driver. Therefore, in the detection system 2000, the power supply devices 500 are provided at various locations of the steering wheel 1000B so as to make the detection device 1 worn on the finger Fg more likely to approach one of the power supply devices 500. In the present embodiment, the case is described where the detection system 2000 includes the multiple power supply devices 500, but the detection system 2000 may be configured such that one power supply device includes a plurality of the power transmission coils 511. The steering wheel 1000B may be configured such that at least the power transmission coil 511 is provided near a surface approached by the finger Fg.

As described above, in the detection system 2000, when the person to be authenticated wearing the detection device 1 operates the steering wheel 1000B, the detection device 1 approaches one of the power supply devices 500, and the coil 411 of the detection device 1 is magnetically coupled to the power transmission coil 511 of the power supply device 500 to automatically charge the battery 300. Thus, the detection system 2000 can charge the battery 300 without the removal of the detection device 1 from the finger Fg while the detection device 1 is in proximity to the power supply device 500. As a result, when operating the steering wheel 1000B, the person to be authenticated can cause the detection system 2000 to charge the detection device 1 and continuously collect information by keeping wearing the detection device 1.

### Fourth Embodiment

Detection System

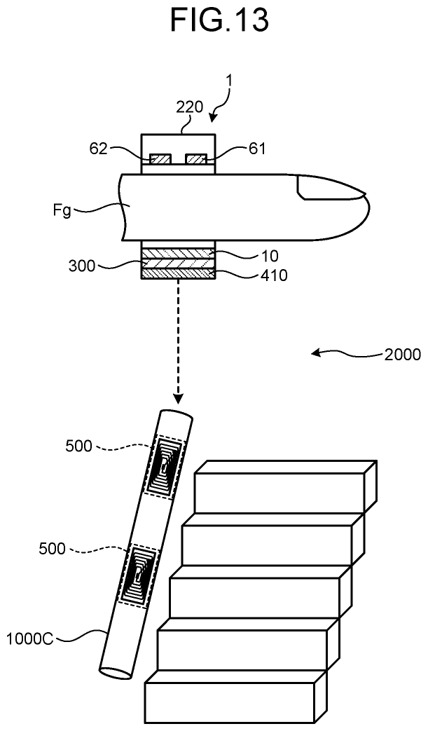

FIG. 13 is a configuration diagram illustrating an exemplary system configuration of the detection system according to a fourth embodiment. As illustrated in FIG. 13, the detection system 2000 includes the detection device 1 worn on the finger Fg and a plurality of the power supply devices 500 that wirelessly supply power to the detection device 1. The detection device 1 is the detection device 1 according to the first embodiment, and includes the housing 200, the light sources 60, the optical sensor 10, the battery 300, and the wireless power receiving element 410. Each of the power supply devices 500 is the power supply device 500 according to the first embodiment, and includes the power transmission coil 511 for transmitting power and the power supply 520 that supplies the power to the power transmission coil 511.

The respective power supply devices 500 are provided at different locations of a handrail 1000C serving as the operation target object 1000 attached to an edge of stairs, a veranda, a bridge, a pathway, and the like. The operation target object 1000 includes an object to be held by the person to be authenticated. The handrail 1000C includes a cross bar and a fence, and various parts are grasped by passersby. Therefore, in the detection system 2000, the power supply devices 500 are provided at various locations of the handrail 1000C so as to make the detection device 1 worn on the finger Fg more likely to approach one of the power supply devices 500. In the present embodiment, the case is described where the detection system 2000 includes the multiple power supply devices 500, but the detection system 2000 may be configured such that one power supply device includes a plurality of the power transmission coils 511. The handrail 1000C may be configured such that at least the power transmission coil 511 is provided near a surface approached by the finger Fg.

As described above, in the detection system 2000, when the person to be authenticated wearing the detection device 1 grasps the handrail 1000C, the detection device 1 approaches one of the power supply devices 500, and the coil 411 of the detection device 1 is magnetically coupled to the power transmission coil 511 of the power supply device 500 to automatically charge the battery 300. Thus, the detection system 2000 can charge the battery 300 without the removal of the detection device 1 from the finger Fg while the detection device 1 is in proximity to the power supply device 500. As a result, when operating the handrail 1000C, the person to be authenticated can cause the detection system 2000 to charge the detection device 1 and continuously collect information by keeping wearing the detection device 1.

### Fifth Embodiment

Detection System

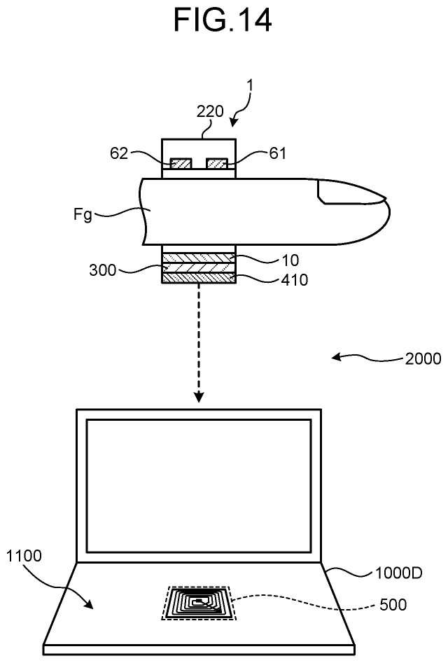

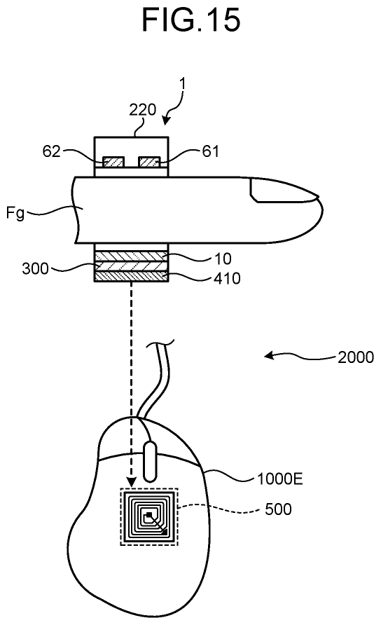

FIG. 14 is a configuration diagram illustrating an exemplary system configuration of the detection system according to a fifth embodiment. FIG. 15 is a configuration diagram illustrating another exemplary system configuration of the detection system according to the fifth embodiment. As illustrated in FIGS. 14 and 15, the detection system 2000 includes the detection device 1 worn on the finger Fg and one or a plurality of the power supply devices 500 that wirelessly supplies (supply) power to the detection device 1. The detection device 1 is the detection device 1 according to the first embodiment, and includes the housing 200, the light sources 60, the optical sensor 10, the battery 300, and the wireless power receiving element 410. Each of the power supply devices 500 is the power supply device 500 according to the first embodiment, and includes the power transmission coil 511 for transmitting power and the power supply 520 that supplies the power to the power transmission coil 511.

As illustrated in FIG. 14, the power supply device 500 is provided in an operating area of input circuitry 1100 of a computer 1000D serving as the operation target object 1000. The computer 1000D is a personal computer, for example. The input circuitry 1100 includes, for example, a keyboard and a touchpad. In the detection system 2000, the power supply device 500 is provided behind or around the input circuitry 1100 so as to make the detection device 1 worn on the finger Fg more likely to approach the power supply device 500. The computer 1000D may be configured such that at least the power transmission coil 511 is provided near a surface approached by the finger Fg.

As described above, in the detection system 2000, when the person to be authenticated wearing the detection device 1 operates the input circuitry 1100 of the computer 1000D, the detection device 1 approaches the power supply device 500, and the coil 411 of the detection device 1 is magnetically coupled to the power transmission coil 511 of the power supply device 500 to automatically charge the battery 300. Thus, the detection system 2000 can charge the battery 300 without the removal of the detection device 1 from the finger Fg while the detection device 1 is in proximity to the power supply device 500. As a result, when operating the input circuitry 1100 of the computer 1000D, the person to be authenticated can cause the detection system 2000 to charge the detection device 1 and continuously collect information by keeping wearing the detection device 1.

As illustrated in FIG. 15, the power supply device 500 may be provided on an input device 1000E serving as the operation target object 1000. Examples of the input device 1000E include a mouse coupled to a computer and a controller coupled to a computer or a game machine. The example illustrated in FIG. 15 illustrates a case where the input device 1000E is the mouse. The input device 1000E is a device operated by the person to be authenticated while being grasped by the person to be authenticated. In the detection system 2000, the power supply device 500 is provided in a portion of an input device 1100E where the finger Fg is positioned so as to make the detection device 1 worn on the finger Fg more likely to approach the power supply device 500.

As described above, in the detection system 2000, when the person to be authenticated wearing the detection device 1 operates the input device 1000E, the detection device 1 approaches the power supply device 500, and the coil 411 of the detection device 1 is magnetically coupled to the power transmission coil 511 of the power supply device 500 to automatically charge the battery 300. Thus, the detection system 2000 can charge the battery 300 without the removal of the detection device 1 from the finger Fg while the detection device 1 is in proximity to the power supply device 500. As a result, when operating the input device 1000E, the person to be authenticated can cause the detection system 2000 to charge the detection device 1 and continuously collect information by keeping wearing the detection device 1.

### Sixth Embodiment

Detection System

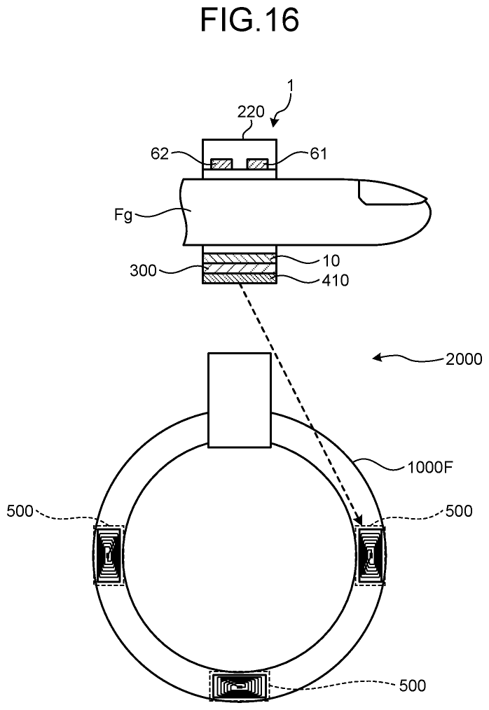

FIG. 16 is a configuration diagram illustrating an exemplary system configuration of the detection system according to a sixth embodiment. As illustrated in FIG. 16, the detection system 2000 includes the detection device 1 worn on the finger Fg and a plurality of the power supply devices 500 that wirelessly supply power to the detection device 1. The detection device 1 is the detection device 1 according to the first embodiment, and includes the housing 200, the light sources 60, the optical sensor 10, the battery 300, and the wireless power receiving element 410. Each of the power supply devices 500 is the power supply device 500 according to the first embodiment, and includes the power transmission coil 511 for transmitting power and the power supply 520 that supplies the power to the power transmission coil 511.

Each of the power supply devices 500 is provided at different locations of a hanging strap 1000F of a vehicle. Examples of the vehicle include an electric train and a bus. The hanging strap 1000F is a ring-shaped member that is hung from above in an interior of the vehicle and is grasped by a standing passenger to support the own body. Therefore, in the detection system 2000, the power supply devices 500 are provided at various locations of the hanging strap 1000F so as to make the detection device 1 worn on the finger Fg more likely to approach one of the power supply devices 500. In the present embodiment, the case is described where the detection system 2000 includes the multiple power supply devices 500, but the detection system 2000 may be configured such that one power supply device includes a plurality of the power transmission coils 511.

As described above, in the detection system 2000, when the person to be authenticated wearing the detection device 1 grasps the hanging strap 1000F, the detection device 1 approaches the power supply device 500, and the coil 411 of the detection device 1 is magnetically coupled to the power transmission coil 511 of the power supply device 500 to automatically charge the battery 300. Thus, the detection system 2000 can charge the battery 300 without the removal of the detection device 1 from the finger Fg while the detection device 1 is in proximity to the power supply device 500. As a result, when operating the hanging strap 1000F, the person to be authenticated can cause the detection system 2000 to charge the detection device 1 and continuously collect information by keeping wearing the detection device 1.

The components in the embodiments and the modification described above can be combined as appropriate. Other operational advantages accruing from the aspects described in the present embodiments of the present invention that are obvious from the description herein, or that are conceivable as appropriate by those skilled in the art will naturally be understood as accruing from the present invention.

What is claimed is:

1. A detection device comprising:
a ring-shaped housing wearable on a living body;
a light source provided inside the housing;
an optical sensor provided inside the housing;
a battery; and
a wireless power receiving element configured to charge the battery, wherein
the optical sensor is provided in an area facing the light source inside the housing, and
a coil of the power receiving element is provided outside the optical sensor in the housing.

2. The detection device according to claim 1, wherein the battery is provided between the optical sensor and the coil.

3. The detection device according to claim 2, wherein the housing is a finger ring.

4. The detection device according to claim 3, wherein the housing is formed of a ceramic.

5. The detection device according to claim 4, wherein the light source comprises a first light source configured to emit near-infrared light and a second light source configured to emit red light.

6. The detection device according to claim 5, wherein a plurality of the first light sources and a plurality of the second light sources are alternately arranged.

7. A detection system comprising:
a detection device; and
a power supply device configured to supply power to the detection device, wherein
the detection device comprises:
a ring-shaped housing wearable on a living body;
a light source provided inside the housing;
an optical sensor provided inside the housing;
a battery; and
a wireless power receiving element configured to charge the battery,
the optical sensor is provided in an area facing the light source inside the housing,
a coil of the power receiving element is provided outside the optical sensor in the housing, and
the power supply device comprises a power supply element capable of supplying power to the power receiving element of the detection device.

8. The detection system according to claim 7, wherein an alternating-current voltage is to be applied to the power supply element.

9. The detection system according to claim 7, wherein the power supply element is provided in a mobile phone.

10. The detection system according to claim 7, wherein the power supply element is provided in a steering wheel of a mobile object.

11. The detection system according to claim 7, wherein the power supply element is provided in a handrail to be contacted by an object wearing the detection device.

12. The detection system according to claim 7, wherein the power supply element is provided in an input device of a computer.

13. The detection system according to claim 7, wherein the power supply element is provided in a hanging strap of a mobile object.
